(19) United States
(12) Patent Application Publication
(10) Pub. No.: US 2005/0149414 A1
(43) Pub. Date: Jul. 7, 2005

(54) RFID system and method for managing out-of-stock items

(75) Inventors: Ivan B. Schrodt, Sherwood, WI (US); Jeffrey D. Lindsay, Appleton, WI (US); Jennifer Marvin, Greenville, WI (US); Michael D. O'Shea, Neenah, WI (US); Gregory Benrud, Neenah, WI (US)

Correspondence Address: DORITY & MANNING, P.A., POST OFFICE BOX 1449, GREENVILLE, SC, 29602-1449, US

(73) Assignee: KIMBERLY-CLARK WORLDWIDE, INC.

(21) Appl. No.: 10/748,691

(22) Filed: Dec. 30, 2003

(51) Int. Cl. G06F 17/60

(52) U.S. Cl. 705/29

(57) ABSTRACT

An RFID method and system for preventing product out-of-stock conditions in a retailer supply chain is disclosed. RFID smart tags are associated with products in a place of purchase or a place of selection of such products. Each distinct product may be associated with at least one smart tag, the smart tags containing identification information regarding their respective product. RFID smart tag readers are used to obtain real time inventory data that may be used in a method for prevent product out-of-stock conditions thereby reducing the number of lost sales that may result from out-of-stock events. In addition, such real time inventory data is also be used in a process to reduce the number of lost sales resulting from out-of-stock events.

### TECHNICAL FIELD OF THE INVENTION

The present invention relates to a system and method for managing inventory and out-of-stock conditions using radio frequency identification systems, particularly in the retail market.

### BACKGROUND

Supply Chain Management (SCM) is a common problem for any organization involved in the design, manufacture and distribution of goods. SCM is particularly important in retail organizations where the successful management of product inventory and the promotion of consumer satisfaction are essential for efficient operation, consumer loyalty, and optimal profit margins. Common SCM activities for a retailer include inventory control at individual retailer stores, inventory control at retailer distribution centers, product supplier network development, purchasing and marketing. Adequate SCM processes reduce occurrences of out-of-stock events, minimize inventory level requirements and increase profit margins while improving the quality of customer service. Conversely, inadequate SCM processes may result in the failure to deliver goods on time resulting in out-of-stock events, which often result in cancelled orders and lost sales or reduced price sales. In addition, inadequate SCM processes can result in longer product replacement cycles and wasteful duplication of resources adding to product cost and reducing profit margins.

The successful management of the supply chain requires accurate recording and tracking of product information as a product progresses from manufacture to the customer's shopping cart. The product information a retail organization may track includes information about the product history (e.g., manufacturer, product description, lot numbers) and product availability (e.g., on-site stock inventory, distributor inventory, delivery time). One example of a prior art system that manually tracks such product information is the written record (e.g., manually writing product information on paper). Manual systems, however, are time consuming, labor intensive and are prone to human error. One improvement over such a manual system is the well known optically based bar code system. Optical bar code systems are typically less time consuming, provide an increased level of automation, and typically provide more accurate data compared to manual systems. However, optical bar code systems are generally limited in the amount of information that can be transferred from the product to the optical scanner, have an inherent product to scanner line-of-site limitation and are susceptible to error in dirty and other hostile environments.

Many tools have been proposed for improved SCM, including the use of bar codes and radiofrequency identification (RFID) tags with suitable computer systems for tracking inventory and improving logistics. RFID in particular has been proposed for tracking pallets and even individual products, using unique electronic product codes and multiple RFID scanners. RFID readers embedded in shelves, known as “smart shelves,” have been proposed for tracking retail inventory on the shelf and automatically generating alerts when a product has been depleted on the shelf. However, even with smart shelves and RFID tracking of inventory, there will continue to be moments when the product a consumer seeks is not available or not on a display shelf or not readily locatable, resulting in a real or apparent “out of stock event.” It is known that in a large percentage of real out of stock events, the desired product is available a short distance away, typically in the stock room of the store. Even though the product may be present elsewhere in the store and may soon be restocked, the consumer who experiences a real or apparent out of stock event may leave the store or abandon plans to purchase the desired product, resulting in lost revenue for the store.

Currently, when a product is out of stock, there is generally no automated means of informing the consumer about the time required to restock the items when they are readily available (e.g., in the stock room), nor automated means of motivating the consumer to continue shopping after encountering an out of stock event. Manual systems are known, such as a clerk offering a rain check for an item on sale when the item is out of stock, but such manual systems are labor intensive and require significant initiative and patience on the part of consumers, many of whom may be discouraged by the out of stock event and simply leave the store or drop the item from their shopping list, perhaps to be purchased later at another establishment.

Thus, a need exists for an improved SCM system that will address at least certain of the draw backs and limitations of conventional systems, and offer benefits not achievable with the present systems. What is needed is an improved SCM system to better accommodate consumers who encounter an out of stock event. In particular, what is needed is an improved SCM system in which consumers who encounter an out of stock event are provided with information and optional incentives to motivate them to remain in the store until the missing product is made available to them, or to provide other incentives or assistance to the consumer to reduce the revenues lost to the retailer due to out of stock events.

### SUMMARY

Objects and advantages of the invention will be set forth in the following description, or may be obvious from the description, or may be learned through practice of the invention.

The present invention relates to novel implementations of Radio Frequency Identification (RFID) technology to assist organizations, particularly retail establishments (e.g., grocery stores, department stores, and the like) and those who produce or provide goods for such establishments, with various aspects of Supply Chain Management (SCM) by providing real-time (or near real time), highly accurate product information with a high degree of automation.

Specifically, RFID technology is applied with other electronic and automated tools to provide methods and systems for assisting consumers who encounter an out of stock event by providing information to the consumer to indicate when (and/or where) the produce will be available and optionally to provide incentives for a consumer to continue making purchases. Such incentives may include discounts or other promotions to reward a consumer for waiting for a product to be restocked. Alternatively, when a product cannot be restocked in a “reasonable amount of time,” incentives may be offered to encourage the customer to purchase an in-stock alternative product or to return later when the product is available. Ideally, each customer is presented with an estimate as to the amount of time required to restock a product so that each customer can determine how long a “reasonable amount of time” happens to be.

In one aspect, the improved SCM system of the present invention builds upon a backbone of advanced RFID-based SCM systems, in which goods can be tracked at the pallet level and optionally at the case or product level through the supply chain using RFID tags associated with the pallets, cases, or individual items, respectively, wherein the RFID tags contain electronic product codes that can be read by RFID scanners to record the locations as well as movement of such items. RFID-based tracking of the items in the supply chain may be used to provide information to a retail establishment about shipments en route or scheduled shipments to assist in forecasting inventory levels. Further, RFID-based tracking information relating to items already in a retail establishment and/or items accessible by a retail establishment can be used to schedule restocking events as well as provide for rapid restocking processes when an item needs to be restocked (e.g., when a predetermined number of the item in question is remaining on the shelf or when the item has been depleted). Tracking of items in a retail establishment or accessible by a retail establishment can include any or all of tracking incoming items at a loading dock or other receiving station, tracking items in the stockroom or other inventory storage locations (including off-site locations such as a nearby warehouses or others stores), tracking items on the shelves of a retail establishment or in other locations, tracking items in shopping carts or at a point of sale.

A properly designed wireless based inventory system according to aspects of the present invention will provide significant improvements in tracking product information by minimizing or eliminating the previously described problems associated with manual systems and optical bar code systems. One possible wireless technology that could be used in an inventory system is a Radio Frequency Identification Device (RFID) based system. Radio Frequency Identification Devices and associated systems are well suited for SCM applications. RFID systems may include low-cost electronic tags, passive “smart” chips or “tags” that can be embedded in or attached to articles, products, and the like to convey information about the product via a smart tag scanner.

As used herein, the term “convey” as used with respect to information from wireless signal generation electronic tag devices such as RFID tags and related wireless devices means that the device can provide information either directly (the data of interest is contained, written, printed, programmed, or otherwise included or stored within or upon the electronic tag device itself), or indirectly (at least some data of interest is contained, written, printed, programmed, or otherwise included or stored within or upon a data storage source other than that the electronic tag device itself and can be accessed using information from the electronic tag device).

An example of a wireless electronic tag device constructed to directly provide information is a read-write RFID tag which has written thereon specific information about a product, such as identity or price information, and communicates such information when sensed by a suitable sensor, as will be described below. An example of a wireless device constructed to indirectly provide information is a read-only RFID tag that, when sensed, communicates limited information, such as a product identity (e.g., a unique electronic product code or categorical identifier), and that product identity is thereafter linked with additional information, such as the product price, stored elsewhere, such as in an electronic database. For example, the electronic product code on a read-only RFID tag, such as a 96-bit passive RFID tag, is a unique serial number which can contain strings that identify the manufacturer and product category, and which can serve as a unique pointer in an electronic database to provide access to stored information such as product composition, manufacturing history, details of the products' supply chain history (dates and times of various shipments, locations of storage, etc.), and its present location and status, all of which can be conveyed electronically by scanning the code associated with the RFID tag and then accessing suitable databases to retrieve information associated with the code.

RFID tags (sometimes referred to as “smart tags”) are generally small label-like devices with a micro-chip and a miniature embedded antenna. Such tags may be passive or active, the active tags requiring an internal power supply. A reader or scanner interrogates the smart tag with an electronic “trigger” signal. The tag in turn generates an electromagnetic signal response that is readable by the scanner, the response containing the product information. RFID tags can be embedded in or attached to product packaging, or incorporated directly into the product, and may convey conventional “bar code” information, as well as other more detailed information.

Such RFID tools and associated systems provide the ability to reliably and automatically obtain real-time product information for individual products throughout the supply chain. In addition, RFID systems are well suited for use in product environments where optical systems do not work reliably. Using RFID technology, product information can be made available while the product is at a manufacturing facility, in transit, at a distribution center and at a point of sale.

At the retail level, RFID technology improves the management of retail stock by providing a method of collecting an accurate real-time inventory record. This allows retailers to better service consumers by recognizing and quickly responding to trends in consumer buying habits. Further SCM process enhancements can be gained by linking a RFID system to a computer network, such as the Internet. Using the Internet in conjunction with an RFID system, a consumer can access a retailer's website and obtain real-time product information, such as the quantity of a product that a retailer has in stock.

Additional benefits from connecting a RFID based inventory system to a computer network (such as the Internet) relate to the various information sources that may be monitored. Such monitoring can provide a source of data that can be used to predict changes in customer buying habits. For example, it has been well established that weather conditions can influence consumer buying habits. A prediction of snow may result in more consumer purchases of bread and milk. Similarly, a prediction of rain, cold weather and hot weather may result in more consumer purchases of umbrellas, coats and fans respectively. Several Internet websites provide local weather conditions and predictions. Thus, an exemplary SCM system that combines automatically monitoring such websites with obtaining real-time inventory information supplied by an RFID system would more accurately predict potential product out-of-stock conditions. Such a system would provide improvements in retailer responsiveness to consumer buying patterns and help prevent products from becoming out of stock as well as facilitate the quick ordering and restocking of products with low inventory levels.

Another important facet of a well designed SCM system at the retail level is customer assistance in locating a desired product, which is particularly important in huge retail stores that carry increasingly diverse products (i.e., superstores, “big box” stores, etc.). Such retail stores necessarily require consumers to traverse large distances, typically on foot, to complete their shopping experience. In addition, should such a retail store not have a desired product in stock, an increasingly annoyed consumer may search the entire store before coming to such a conclusion. While a consumer may alternatively seek out store personnel and ask for product information, such store personnel may themselves be difficult to locate and when located, may or may not know the desired information. Consequently, there is a need for a system that supplies the most direct route a consumer may take to obtain desired in-stock products and to eliminate unnecessary searches for products that are either not carried or are currently out of stock and suggest possible substitute products.

A methodology and system according to the invention involves, in general aspects, the use of RFID smart tags, combined with a process for obtaining RFID smart tag information, so as to provide the ability to acquire product inventory information across a supply chain. The disclosed methodology may be used, for example, in a supply chain that includes a manufacturer computer and database associated with a manufacturing location, a distribution center computer and database associated with a distribution center and a retailer computer and database associated with a particular retail store. The smart tags may be associated with a product at the manufacturing facility and coded with product information, such as the name of the product, type or category of product, manufacturer of the product, and so forth. RFID Smart Tag Readers (STR) may be made available at various points along the supply chain in a number of conceivable scenarios according to the invention. Such RFID STR devices may be configured to interrogate RFID smart tags to obtain the information stored in such tags. The RFID STR devices may also be configured to use various techniques for ascertaining the RFID smart tag location. The RFID STR devices may then transfer such information to another electronic device, such as a computer. The electronic device may then use such product information in an inventory control process as well as transfer selective information to a customer interface with the goal of enhancing a customer's shopping experience.

It should be noted that the disclosed methodology may be implemented at various points along the supply chain. For example, the disclosed methodology may be used at the retailer store level only. In such an implementation, the RFID smart tags may be associated with the product at any location within the supply chain.

In one particular embodiment of the system and methodology according to the invention, the smart tags are associated with each distinct product, preferably at the place of manufacture. The smart tags may be in the form of adhesive labels or the like that are attached directly to the product packaging, or to a separate container that holds the product. The RFID tagged products are then placed in customer display inventory locations. Exemplary customer display inventory locations include store shelves, refrigeration units, store cabinets, etc., wherever products are located for customer viewing. RFID tagged products may also be placed in retailer storage inventory locations. One well known exemplary retailer storage inventory location is the in-store stock room.

In this embodiment, at least one RFID Smart Tag Reader (STR) is provided in communication range of each distinct product. For example, one RFID STR device can be moved throughout the retailer store covering all the customer display inventory locations and retailer storage inventory locations. Similarly, an array of RFID STR devices can be moved throughout the retailer store. In the alternative, an array of fixed RFID STR devices can be used. The RFID STR devices are configured to communicate with a central computer and its associated hardware and software. Such a central computer is preferably located at the retailer store (retailer central computer) but may also be a customer interface or any other suitable electronic device used for data processing.

The central computer is additionally configured to communicate with a customer interface. One exemplary embodiment of a customer interface is an electronic device comprising a processor, memory and a LCD screen and is preferably located on a shopping cart or other similar apparatus used by customers while shopping. The customer interface is configured to receive a customer request for a desired product and transmit such request to the central computer. The central computer may then request an RFID STR device to provide real time product information. The central computer receives the real time product information from the RFID STR device and transfers at least part of such information to the customer interface. Alternatively, the customer interface may communicate directly with the RFID STR device.

The central computer may be further configured to determine when a customer issues a desired product request for a product not sold by the retailer. In this case, the central computer may transfer a product-not-sold message to the customer interface. In addition, the central computer may be configured to search for possible alternative products that are sold by the retailer, request a RFID STR device to provide real-time product information for such alterative products and then transfer such product information to the customer interface. An alternative-product-purchase incentive may also be transferred to the customer interface.

The central computer may suggest alternative products to a consumer when a desired product is not sold or when there is an out of stock condition, particularly when a desired product cannot be restocked within a predetermined length of time (e.g., 1 minutes, 2 minutes, 5 minutes, 10 minutes, or 15 minutes). If more than one alternative product may be suitable and is in stock, the manufacturers may compete electronically (electronic auction) for the right to promote their product to the consumer. For example, a first manufacturer may offer a 10 cents payment to the retailer to offer a first product as an alternative to a sought out-of-stock product, while a second manufacturer may offer a 15 cents payment to the retailer to promote a second product. The offered payments may have been previously fixed by the vendor for use with an auction algorithm, or may be selected based on known information about the consumer. The retailer can then automatically select the product to promote, typically based on which product will bring the highest payment or highest net profit to the retailer, and the product may then be promoted as an alternative.

The central computer may also be configured to determine when a desired product sold by the retailer is in retailer storage inventory but not in customer display inventory. In this case, the central computer may issue a customer display inventory restock request for the desired item, ascertain an estimated restock time and transfer such restock time to the customer interface. A wait-to-purchase incentive may also be transferred to the customer interface.

The central computer may also be configured to determine when a desired product inventory level is at a predetermined amount below the inventory level of a possible substitute product. In this case, the central computer may transfer the substitute product information to the customer. A substitute-product-purchase incentive may also be transferred to the customer interface.

In another embodiment of the present invention, RFID technology is used to provide real-time (or near real-time) retailer on-site inventory data. RFID tags are associated with each distinct product at any point along the supply chain, but preferably before placing such products in customer display locations or retailer storage locations. A central computer is configured to communicate with at least one RFID STR device to obtain a customer display inventory count for each distinct product. Such customer display inventory count is compared to a predefined customer display inventory minimum value. When the customer display inventory count drops below such minimum value, a customer display inventory restock request is generated.

The central computer may be further configured to monitor an information-data source. One exemplary information-data source is an Internet based service or private web service that provides current weather conditions and predictions. For example, the central computer may monitor a weather related website for predictions of snow. When such a prediction is detected, the central computer would access the relevant event criteria for the products sold by the retailer. The central computer would then make any necessary adjustments to the customer display inventory minimum value for products sold by the retailer. The central computer may also be configured to perform the same basic steps for products in both customer display inventory and retailer storage inventory.

In yet another embodiment of the present invention, RFID technology is used to provide real-time (or near real-time) inventory data at the retailer on-site inventory level as well as the distribution center level. RFID tags may be associated with each distinct product at any point before and including the distribution center, but preferably before placing such products in distribution center storage locations. A central computer is configured to communicate with at least one RFID STR device to obtain a distribution center inventory count for each distinct product. Such distribution center inventory count is compared to a predefined distribution center inventory minimum value. When the distribution center inventory count drops below the minimum value, a distribution center inventory restock request is generated. The central computer may be further configured to monitor an information-data source as described above.

Additional embodiments of the present subject matter, not necessarily expressed in this summarized section, may include and incorporate various combinations of aspects of features or parts referenced in the summarized objectives above, and/or features or components as otherwise discussed in this application.

Those of ordinary skill in the art will better appreciate the features and aspects of such embodiments, and others, upon review of the remainder of the specification.

### BRIEF DESCRIPTION OF THE DRAWINGS

A full and enabling description of the present subject matter, including the best mode thereof, directed to one of ordinary skill in the art, is set forth in the specification, which makes reference to the appended figures, in which:

FIG. 1 is a block diagram illustration of an exemplary supply chain incorporating an RFID system in accordance with one possible embodiment of the invention;

FIG. 2 is a graphic illustration of products and associated RFID smart tags in a customer inventory location;

FIG. 3 is a logical flow chart of an exemplary Customer-Care routine according to the invention;

FIG. 4 is a logical flow chart of an exemplary High-Inventory-Product routine according to the invention;

FIG. 5 is a logical flow chart of an exemplary Restock CDI routine according to the invention;

FIG. 6 is a logical flow chart of an exemplary Out-of-Stock routine according to the invention;

FIG. 7 is a logical flow chart of an exemplary Retailer-Inventory-Monitor routine according to the invention;

FIG. 8 is a logical flow chart of an exemplary Information-Source-Monitor routine according to the invention;

FIG. 9 is a logical flow chart of an exemplary Inventory-Monitor for a manufacturing facility and a distribution center according to the invention; and

FIG. 10 is a logical flow chart of an exemplary Information-Source II-Monitor routine according to the invention.

Repeat use of reference characters throughout the present specification and appended drawings is intended to represent the same or analogous features or elements of the present technology.

### DETAILED DESCRIPTION

Reference will now be made in detail to one or more embodiments of the invention, examples of which are graphically illustrated in the drawings. Each example and embodiment is provided by way of explanation of the invention, and not meant as a limitation of the invention. For example, features illustrated or described as part of one embodiment may be utilized with another embodiment to yield still a further embodiment. It is intended that the present invention include these and other modifications and variations.

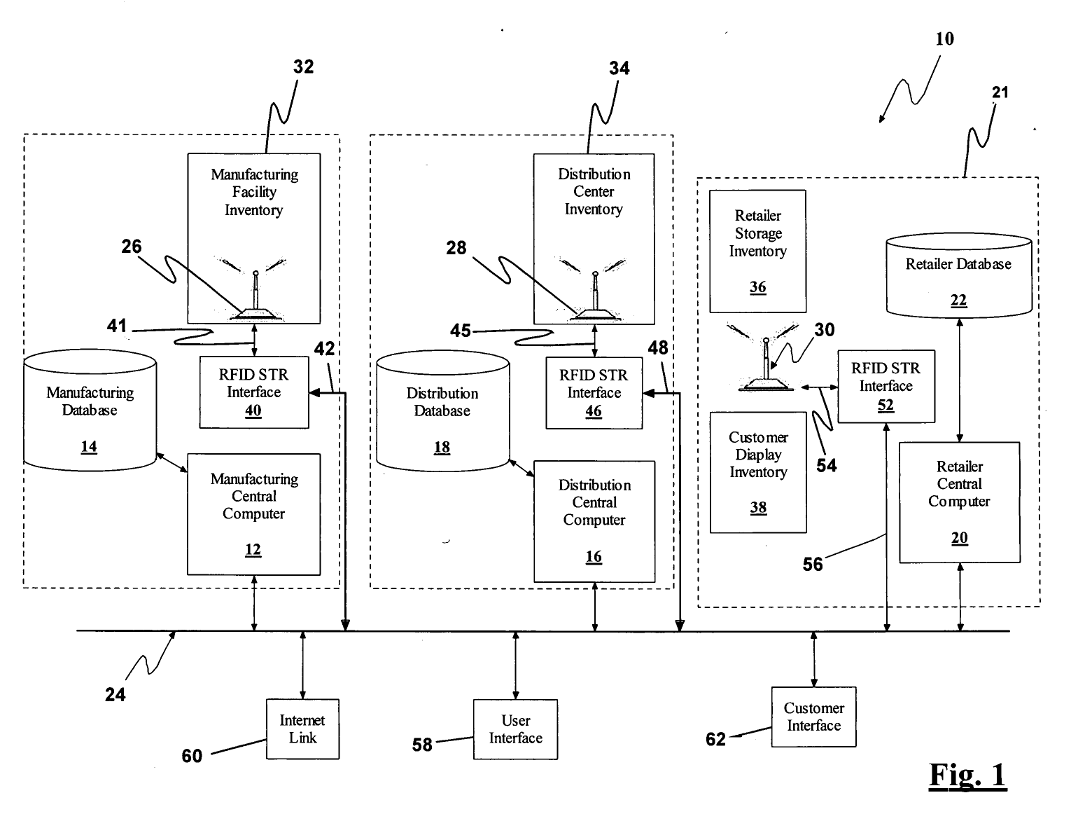

FIG. 1 is a block diagram illustration of an exemplary RFID based inventory system 10 depicting various components of a supply chain in accordance with one embodiment of the present invention. Exemplary RFID system 10 represents a retail supply chain for any type of product and includes a manufacturing central computer 12 associated with a manufacturing database 14, a distribution central computer 16 associated with a distribution database 18 and a retailer central computer 20 associated with a retailer database 22, all interconnected via a standard wired and/or wireless communication link 24. It should be appreciated that any one of the manufacturing central computer 12, distribution central computer 16 and retailer central computer 20 may be connected to a common database without departing from the scope of the disclosed technology and methodology. For example, distribution database 18 and retailer database 22 may be incorporated into a single database.

RFID STR 26, 28, and 30 are smart tag readers (sometimes referred to as RFID scanners) of conventional design and are used to retrieve the information contained in RFID smart tags. RFID STR devices 26, 28 and 30 are electronic devices that may, for example, comprise an RF transmitter and receiver and an antenna to communicate with RFID transponders, such as RFID smart tags. Such RFID STR devices may include a microprocessor and software programs for this purpose. Exemplary readers include Matrics® Advanced Readers manufactured by Matrics, Inc. (Columbia, Md.), Alien Technology (Morgan Hill, Calif.), or Philips Semiconductor (Eindhoven, The Netherlands). Another example of an RFID STR device is an RFID reader manufactured by Antenova Ltd. (Cambridge, England) or Bancolini B30 handheld RFID Scanner manufactured by Bancolini (Bologna, Itally).

RFID STR devices 26, 28 and 30 may be accessed through RFID STR interface 40, 46 and 52 respectively. Such RFID STR interfaces may be, for example, a standard PC or PDA device incorporating a digital interface designed to facilitate communication between RFID STR devices and a computing device connected to wired or wireless communication link, such as link 42. RFID STR interface 40, 46 and 52 may comprise a gateway for connecting two, systems. Interface 40, 46 and 52 may also be incorporated into manufacturing central computer 12, distribution central computer 16 and retailer central computer 20 respectively.

RFID Smart Tag Reader (STR) 26, 28 and 30 represent one or more RFID STR devices disposed at various locations along RFID system 10. To facilitate remote access to such RFID STR devices, a networking system, such as a local area network (LAN) may be utilized. In the preferred embodiment, such RFID STR devices incorporate a TCP/IP protocol suite and an HTTP (HyperText Transfer Protocol) server to provide two-way access to the RFID STR data. Such TCP/IP protocols and HTTP server technology are well known in the art. For such an embodiment, the RFID STR devices include an HTTP server and a TCP/IP protocol stack. The RFID STR interfaces 40, 46 and 52 preferably provide a gateway which enables continuous remote access to the RFID STR devices.

Generally speaking, a gateway may simply be a means for connecting two already compatible systems. Alternatively, a gateway may be a means for connecting two otherwise incompatible computer systems. For such an alternative configuration, the TCP/IP protocol suite may be incorporated into a gateway serving multiple RFID STR devices via a wired or wireless two-way network using, for example, Wireless Fidelity (Wi-Fi) technology. Such gateway may incorporate an HTTP server for accessing data from multiple RFID STR devices and for transmission of data to individual RFID STR devices.

In the above described TCP/IP enabled RFID STR systems, communications link 24 provides access to a first network operating in accordance with a predetermined protocol (TCP/IP is one example). A plurality of RFID STR devices may comprise a second network, such as a LAN. A gateway operatively couples the first network to the second network. Finally, an HTTP server is embedded in either the gateway or the plurality of RFID STR devices facilitating the transfer of data between the two networks. With such a configuration, one of ordinary skill in the art will appreciate that individual RFID STR devices or groups of RFID STR devices may be accessed as if the STR devices were a web site and their information could be displayed on a web browser.

Such technology is fully disclosed by Ardalan et al. in U.S. Pat. No. 6,363,057 for use in a system for communicating with electricity meters, which is hereby incorporated by reference for all purposes.

Again referring to FIG. 1, RFID Smart Tag Reader (STR) 26 represents one or more STR devices located at manufacturing facility inventory 32. STR 26 is connected to RFID STR interface 40 via wired or wireless communications link 41. With such a configuration, either of manufacturing central computer 12, distribution central computer 16, retailer central computer 20, user interface 58 and any properly configured computing device connected to communications link 24 may transmit and receive data to and from RFID STR 26.

Similarly, STR 28 represents one or more STR devices located at distribution center inventory 34. STR 28 is connected to RFID STR interface 46 via wired or wireless communications link 45. With such a configuration, either of manufacturing central computer 12, distribution central computer 16, retailer central computer 20, user interface 58 and any properly configured computing device connected to communications link 24 may transmit and receive data to and from RFID STR 28.

Similarly, STR 30 represents one or more STR devices located at retailer storage inventory 36 and customer display inventory 38. STR 30 is connected to RFID STR interface 52 via wired or wireless communications link 54. With such a configuration, either of manufacturing central computer 12, distribution central computer 16, retailer central computer 20, user interface 58 and any properly configured computing device connected to communications link 24 may transmit and receive data to and from RFID STR 30.

User interface 58 represents one or more devices designed for providing access to electronic data systems. Such devices include a computer, a terminal, a PDA or any digital device configured for accessing data systems. One or more user interface 58 devices may be located wherever access is required to RFID system 10.

Internet link 60 is a standard Internet link that may provide a two way communication link between RFID system 10 and networks external to the retailer network, although Intranet computers can also be accessed through such a link. For example, potential customers may use Internet link 60 to shop for products sold by a retailer while obtaining real-time product inventory data as well as other information related to such desired products. In addition, retailer central computer 20, distribution computer 16 and manufacturing central computer 12 may utilize Internet link 60 to obtain “information-data”, which will be described in more detail below.

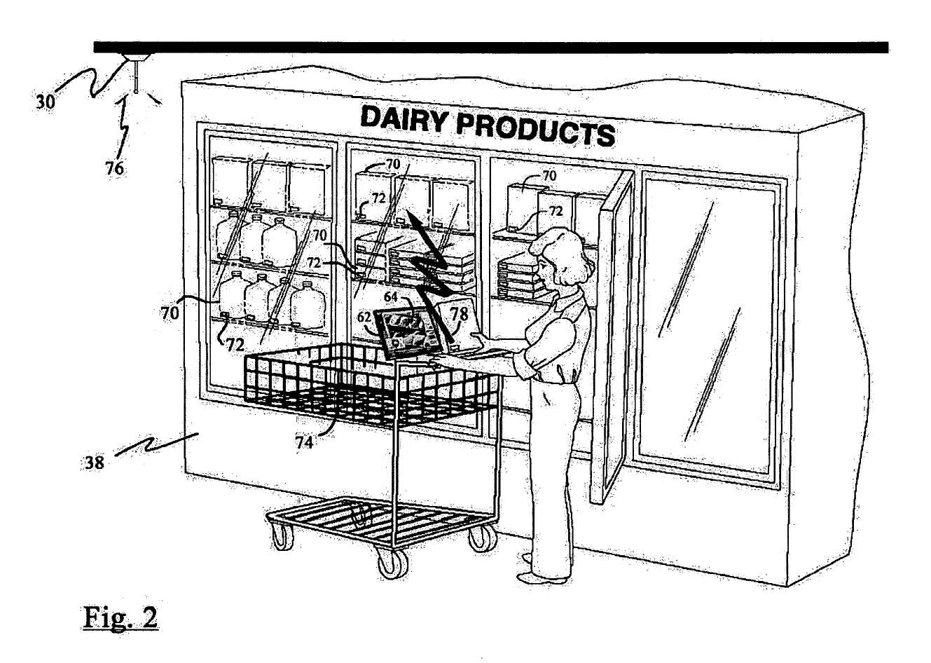

Customer interface 62 is shown in both FIG. 1 and FIG. 2. Customer interface 62 is an electronic device preferably supplied by the retailer and used by a customer while shopping for products in customer display inventory 38. Customer interface 62 may have a conventional hardware and software architectural design suitably adapted for sending message to and receiving messages from a central computer (such as retailer central computer 20) and/or RFID STR devices (such as RFID STR 30). While customer interface 62 is portrayed as having a built-in visual display screen 64 (FIG. 2), it should be recognized that customer display 62 may comprise a plurality of physically separated but cooperatively associated electronic devices that are not shown independently such as a radiofrequency transmitter and receiver, a processor, one or more display means such as a visual display screen 64, a magnetic card reader, an audio speaker, and the like, each communicating with or under control of the a central computer, preferably central computer 20. The customer interface 62 may incorporate an alarm or alert feature wherein the consumer is notified of special product offerings. Customer interface 62 may also comprise a RFID STR device.

Customer interface 62 may comprise a variety of means to communicate information to a consumer. For example, a visual display device may be used to display a readable message. Visual display devices can include an LED display, an LCD display, a plasma screen, computer monitor or PDA device, electronic paper or films capable of displaying text or graphics (e.g., the flat display devices of Power Paper, Ltd. (Einat, Israel), virtual reality headsets and related instrumented glasses (instrumented with video and/or audio play capability), as well as cell phones, including text messaging devices or video cell phones, wherein images can be displayed to convey information or wherein sound can be played or multimedia files played, and the like. Visual display devices may also include printers such as ink-jet printers that can provide printed matter such as printed sheets of paper containing customized information for the consumer, including incentive information such as customized coupons printed from a smart shopping cart or printing device mounted on or near the shelves of an aisle.

In addition to visual display devices, customer interface 62 may include the communication means for conveying audible messages that may be used alone or in combination with other communication tools. Speakers, for example, may project messages audible to consumers standing near a shelf with out-of-stock items. One sound technology that may be used in the present invention is hypersonics, in which narrow “hypersonic” beams of sound can be directed to one or more individuals such that others do not hear the message. Hypersonics sound technology, such as that provided by American Technology (San Diego, Calif.), is described in a white paper entitled, “Theory, History, and the Advancement of Parametric Loudspeakers: A Technology Overview,” by James J. Croft and Joseph O. Norris, Revision D, American Technology Corporation, San Diego, Calif., 2002, available at www.atcsd.com/pdf/HSSWHTPAPERRevD.pdf. Exemplary applications of hypersonic technology are illustrated at www.popsci.com/popsci/hometech/article/0,12543,351353,00.html.

The information conveyed to a consumer via customer interface 62 may include any of the following:
An estimated wait time for restocking an apparently out-of-stock item or when it can be picked up at a predetermined location such as a customer service desk or parcel pickup area outside but typically adjacent the retail establishment. Such information may be based on RFID-enabled SCM data or RFID-enabled information from within the store pertaining to inventory levels or product location on the shelves.
Identification of one or more locations where a desired item may be obtained, including presentation of a map showing the consumer how to get to each a location where the desired product can be obtained, which is particularly helpful when an apparently out-of-stock item is currently on the shelves or otherwise available at one or more other locations in the retail establishment.
Information about discounts (incentives) for waiting for the item to be restocked or supplied to the consumer.
Information about alternate products, optionally including incentives to purchase alternate products.
Directions (including the use of a map) to efficiently take the consumer to another location to obtain the product, an alternate product, a promotional item or incentive, and the like.
Other product information, such as price information, ingredients, promotional information, etc.

Again referring to FIG. 2, exemplary retailer products 70 stored in customer display inventory 38 are shown. In the FIG. 2 illustrated embodiment, the products 70 are food products. It should be appreciated that this is for purposes of illustration only. The products may just as well be clothing items, hardware items, and other staple item of commerce. Such exemplary retailer products 70 are provided or associated with respective RFID smart tags 72. As discussed in greater detail below, smart tags 72 transmit coded pulsed signal 78 containing product information in response to an electronic “trigger” 76 from RFID STR 30.

The smart tags 72 may be attached directly to the products 70, as illustrated in FIG. 2. In this embodiment, the smart tags 72 may be, for example, adhesive backed labels or tags that are attached directly to the packaging of the products 70. Alternatively, such smart tags 72 maybe attached to containers that are specially designed to hold such products. For example, a toothbrush and its associated factory packaging could be placed in a tubular container where a smart tag 72 is attached to said tubular container. Such container may be reusable.

Similarly, the RFID system 10 according to this preferred embodiment of the invention includes a combination of smart tags 72 attached directly to the products as well as the location where such products are to be placed on display for customers to view while shopping. For example, a smart tag 72 may be attached to both the products 70 and the shelves containing the products 70 along with or incorporated with the store's own identification labels. It should be noted that when a product is out-of-stock, there are no products (and associated smart tags) for a RFID STR device to read when performing inventory scans, unless, smart tags are also attached to a particular product's storage area, for example on the product shelf. While such a problem can be compensated for by having a record of where products should be located when in-stock, attaching product smart tags to the product's storage location will enhance the ability to accurately detect product out-of-stock conditions.

Such an embodiment also enhances the ability to detect when a product is in the wrong location. Such a problem seems to have become an absolute plague in hardware stores, for example, where customers remove products from the product's designated customer display inventory location to examine the product and then replace the product in a different location. Smart tags 72 may also be provided on a wall or other structure adjacent to the storage locations for the distinct products.

Still referring to FIG. 2, customer display inventory 38 may comprise RFID-enabled “smart shelves.” Such smart shelves may be a useful tool in tracking product locations on such smart shelves and in identifying or anticipating an out-of-stock event. Smart shelves, which can comprise multiple RFID readers to read RFID tags on a shelf, are disclosed in PCT publication WO 00/65532, “Storage System,” published Nov. 2, 2000, by K. Ashton, the U.S. equivalent of which is herein incorporated by reference for all purposes. Smart shelf units with multiple RFID scanners have been marketed under the name “SmartShelf” by SAMSys Technologies, Inc. (Ontario, Canada). Improved smart shelves have been proposed in which a single antenna or single array of interconnected antennas with a single reader can be used to determine the location along a shelf. One such technology is that discussed by D. G. Bauer et al., “Intelligent Station Using Multiple RF Antennae and Inventory Control System and Method Incorporating the Same,” U.S. Patent Publication 200030174099-A1, published Sep. 18, 2003, filed as U.S. patent application Ser. No. 10/338,892, assigned to MeadWestvaco Corporation.

Another technology for smart shelves that eliminates the need for coaxial cable and is said to provide good resolution on a shelf at low cost is the recirculating phase array antenna system of AWID (Applied Wireless Identification Group, Hollister, Calif.) coupled with a fast look-ahead decay sensing system. Such antenna systems may be provided in roll-to-roll form for retrofitting of existing shelves, as discussed by AWID President, Jeffrey Jacobsen, “Low Cost, Digitally Amplified Shelf Antennas,” Proceedings of the Smart Label Europe 2003 Conference (available on CD-ROM), Cambridge, England, Sep. 29-30, 2003, sponsored by IDTechEx. A film provided with the antennas and conductive leads can be provided for rapid placement on the surface of a shelf where it may be hidden under paper or other materials. Associated with the antenna system are additional electronics for signal reading and processing.

In general, as shown in FIG. 2, a different smart tag 72 is associated with each distinct product. For example, if the retailer carries three different brands of milk, then a different smart tag may be associated with each brand. Similarly, if three different size containers of the same brand of milk are carried by the store, then a different smart tag 72 may be associated with each different sized container.

The product identification information stored in the smart tags 72 is not limited in scope, and may include, for example, information identifying the type of product, brand name of product, manufacturer of the product, etc. The type of product information stored in smart tags 72 is preferably adequate to correlate with various manners of listing desired products. For example, certain consumers may only list “milk” and “butter” in a generic sense in their respective lists of desired products. Different consumers may identify the milk and butter by a particular brand name. The stored product identification information should be adequate to assimilate all reasonable conceivable methods of listing desired products.

With conventional RFID “smart” systems, the smart tags 72 are passive devices. As shown in FIG. 2, RFID STR 30 emits a trigger excitation signal 76 received by an internal antenna in the smart tag 72. This signal 76 causes the smart tag 72 to generate and transmit signal 78, an electromagnetic pulse of coded digital data containing the product identification information. The coded signal 78 is received by the RFID STR 30, decoded, and the product identification information is presented to retailer central computer 20, in any number of ways. Retailer central computer 20 may then transfer any relevant product information to customer display 62. In the alternative, coded signal 78 may be received directly by customer display 62.

RFID smart tag technology is known and understood by those skilled in the art, and a detailed explanation thereof is not necessary for purposes of describing the method and system according to the present invention. Generally, conductive or passive smart tags 72 consist of silicon or other semiconductors, a coiled, etched, or stamped antenna, a capacitor, and a substrate on which the components are mounted or embedded. A protective covering is typically used to encapsulate and seal the substrate. Inductive or passive smart tags have been introduced by Motorola under the name “BiStatix”. A detailed description of the BiStatix device may be found in U.S. Pat. No. 6,259,367 B1, incorporated herein by reference in its entirety for all purposes. Another commercial source of suitable smart tags is Alien Technology Corporation of Morgan Hill, Calif., under the technology name FSA (Fluidic Self-Assembly). With the FSA process, tiny semi-conductor devices are assembled into rolls of flexible plastic. The resulting “smart” substrate can be attached or embedded in a variety of surfaces. The smart tag technology under development at the Auto-ID Center at Massachusetts Institute of Technology (Cambridge, Mass.) can also be used within the scope of the present invention. Further information on smart tags and related technology is disclosed in U.S. Pat. No. 6,451,154, “RFID Manufacturing Concepts,” issued Sep. 17, 2002 to Grabau et al.; U.S. Pat. No. 6,354,493, “System and Method for Finding a Specific RFID Tagged Article Located in a Plurality of RFID Tagged Articles,” issued Mar. 12, 2002 to Mon; PCT publication WO 02/48955, published Jun. 20, 2002; U.S. Pat. No. 6,362,738, “Reader for Use in a Radio Frequency Identification System and Method,” issued Mar. 26, 2002 to Vega; D. McFarlane, “Auto-ID Based Control,” White Paper for the Auto-ID Centre Institute for Manufacturing, University of Cambridge, Cambridge, United Kingdom, Feb. 1, 2002, available at www.autoidcenter.org/research/CAM-AUTOID-WH-004.pdf; and Chien Yaw Wong, “Integration of Auto-ID Tagging System with Holonic Manufacturing Systems,” White Paper for the Auto-ID Centre Institute for Manufacturing, University of Cambridge, Cambridge, United Kingdom, September 2001, available at www.autoidcenter.org/research/CAM-WH-001.pdf. Such references are hereby incorporated herein by reference in their entirety for all allowed purposes.

Other RFID technologies believed to be of value for the present invention includes those produced by Microchip Technologies (Chandler, Ariz.), which provides remote read-write chips at several frequencies. Also of potential value are the I*CODE chips and readers of Philips Semiconductor (Eindhoven, The Netherlands), which, in one embodiment, are said to include 384 bit configurable read/write memory with 64 bits for a unique serial number (e.g., an electronic product code). Sokymat (Lausanne, Switzerland) markets the PICCOLO read-only RFID disc tag which transmits data to a reader station by an AM radio signal. The tag is said to have 64 bits of data that can be programmed during manufacturer by laser fusing of polysilicon links in order to store a unique code on each tag.

Texas Instruments (Dallas, Tex.) offers RFID technology as part of Texas Instruments RFID (TI*RFID™) Systems, formerly known as the TIRIS™ system (Texas Instruments Registration and Identification System), which is used to track and identify various assets using devices such as the TI Tag It™ chip.

Gemplus (Gemenos, France) provides smart tags (sometimes called “smart labels”) and smart cards employing RFID technology, which may be used as smart tags. They also market interfaces, antennas, scanners and software that can be adapted for use with smart tags.

Nedap (Groenlo, The Netherlands) provides smart cards and a13.56 MHz smart tag using RFID technology with 512 bits of read-write memory with a range of about 120 cm. It is claimed that about 20 such tags per second can be read successfully by a scanner.

Checkpoint Systems Inc. (Miami, Fla.) offers a smart tag with WORM technology (write once, read many). One example is the MCRF355 chip, described more fully at www.idsystems.com/reader/1999_{—}05/join0599.htm.

PDA-like reader systems and other portable readers for RFID technology are marketed by Omron Company (Tokyo, Japan), such as the Model V700 or V720 series.

High frequency bands can be used in RFID technology, such as bands between 300 MHz and 10 GHz. SCS Corporation (Rancho Bernardo, Calif.), for example, markets smart tag technology at 2.45 GHz. Ultra-wide band technology can also be adapted for RFID systems.

A related technology within the scope of the present invention is Surface Acoustic Wave (SAW) technology. For example, InfoRay (Cambridge, Mass.) markets a passive smart tag that is said to achieve long ranges (up to 30 meters) using a Surface Acoustic Wave (SAW) device on a chip coupled with an antenna. The SAW device converts a radio signal to an acoustic wave, modulates it with an ID code, then transforms it to another radio signal that is emitted by the smart tag and read by a scanner. The ID code of the smart tag is extracted from the radio signal. The scanner is said to compare the spectral content of the signal with a database of signatures and to derive the ID code. This method enables a read range of up to 30 m (typical 10-20 m). The system can operate in the 915 MHz band and 2.45 GHz band. RFSAW, Inc. (Dallas, Tex.) also provides minute Surface Acoustic Wave (SAW) RFID devices that can be used within the scope of the present invention.

The antenna embedded within the smart tags 72 is generally one component of the device, though it is recognized that alternatives to antennas may exist in some applications. (For example, for some metallic objects, the smart tag need not comprise an antenna but the metallic object itself can serve as the antenna.) The excitation signal 76 from the RFID STR 30 can be received by the antenna to “activate” the smart tag. The received excitation signal 76 is the power source for the smart tag 72 and results in the generation of the electromagnetic pulse containing the coded product identification information signal 78. A detailed description of RFID smart tag antennas may be found in U.S. Pat. No. 6,320,556 B1, incorporated herein by reference for all purposes.

In an alternate embodiment, the smart tags 72 may be active devices. In this configuration, the smart tag 72 includes active transceiving circuitry that has the capability to selectively respond to coded request signals transmitted by a RFID STR 30. The active smart tag 72 may include the capability to delete their fixed code and receive new or additional information beyond the information contained in its fixed code. An active smart tag 72 requires an internal power supply, such as a micro-battery, thin film battery, or the like. Active tags 72 may be desired in the scenarios wherein the tags 72 are mounted at storage locations of particular products. In this way, as different products are stored at the respective locations, the smart tags 72 can be programmed accordingly.

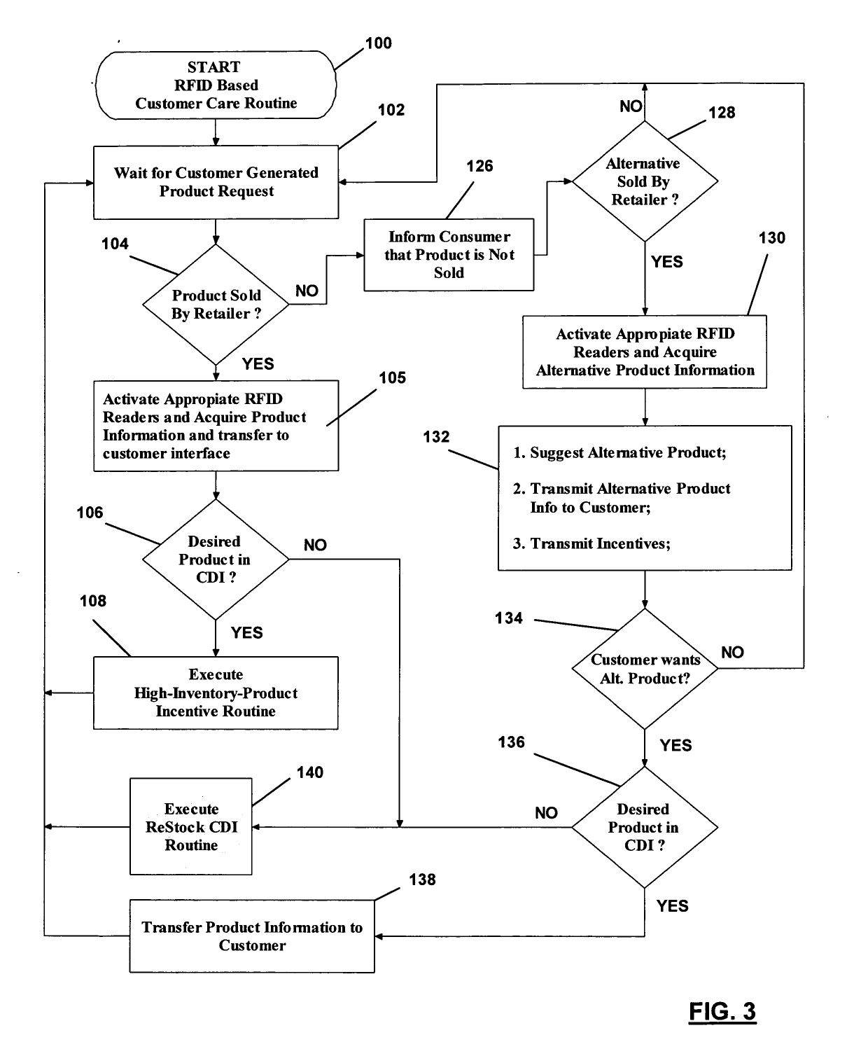

Examples of methodologies for using RFID system 10 are now discussed. FIG. 3 is a high level block diagram depicting exemplary logic for a Customer Care Routine using RFID system 10. Such a customer care routine is preferably implemented in software executed by retailer central computer 20. It should be appreciated, however, that any computer with access to communications link 24 may be the computer executing the customer care routine and hereafter such computer will simply be referred to as the “central computer”. Step 100 marks the entry point into the exemplary customer care routine shown in FIG. 3. At step 102, the central computer is waiting to receive a customer generated product request (directly generated or indirectly generated by a customer via a stored electronic shopping list, for example). When a product request is received, at step 104, the central computer determines if the product is sold by the retailer. Such is preferably accomplished by accessing retailer database 22 and checking a list of retailer products for the requested product. In the alternative, the central computer may scan the retailer's inventory using the appropriate RFID STR devices.

If, at step 104, the central computer determines that the product is sold by the retailer, step 105 is preferably executed where the central computer initiates a desired product information data transfer to customer interface 62. Such product information may be obtained from retailer database 22, distribution database 18, manufacturing database 14, an external data source (via internet link 60), user interface 58 and smart tags 72 associated with the desired product. In the preferred embodiment, the central computer obtains real-time customer display inventory 38 data by accessing the appropriate RFID STR device(s). Alternatively, near real-time data may be obtained.

Near real-time data is generally defined as “old” real-time data that has been stored in a memory but not so old that such near real-time data would likely be significantly different, if different at all, from real time data. For example, suppose that inventory data for product X is requested at 10:00 a.m. and a computer already has inventory data for product X stored in a memory that was generated at 9:59 a.m. The 9:59 a.m. inventory data may be near real-time data. Such near real-time data would likely be quicker and cheaper to access although such data may not represent with 100% accuracy the current inventory status. In contrast, real-time inventory data represents the current inventory status of the product at the inventory location of interest (such as customer display inventory 38) at the moment a RFID STR device scans the relevant inventory location in response to a request for inventory data.

One of ordinary skill in the art will appreciate that what qualifies as “near real-time” data may be dependent on the product of interest. For example, if a retailer typically sells 1 product-X a month and keeps 10 product-Xs in inventory, 1 week old product-X inventory data may qualify as near real-time data. In contrast, if a retailer typically sells 20 product-Ys in a week and keeps 30 product-Ys in customer display inventory, then 1 week old product-Y inventory data probably does not qualify as near real-time data. The criteria for what qualifies as near real-time data would preferably be established for each product using well known statistical concepts and historical data.

At step 106, the central computer uses such customer display inventory 38 data to determine if the desired product is in customer display inventory 38. If the desired product is not in customer display inventory 38, a Restock CDI routine (described later) is executed. Otherwise, step 108 is executed.

At step 108, a High Inventory Product Routine is executed. The goal of the High Inventory Product Routine is to better manage inventory levels by suggesting possible substitute products (substitute to the desired product) where the possible substitute product has an inventory level greater than the desired product inventory level by a predetermined amount. For example, suppose a retailer has 100 jars of Tom's Strawberry Jelly and 500 jars of Jerry's Strawberry Jelly in a retailer inventory location. Now suppose a customer makes a request for Tom's Strawberry Jelly. For such an example, it may be advantageous for the retailer to suggest a Jerry's Strawberry Jelly purchase (and provide any appropriate incentives). Such a routine may also be used to suggest substitute products that are about to become “out-of-date”, such as is often the case for perishable products such as milk. For example, suppose the date is Nov. 25, 2020 and a retailer has a 1 gallon container of Sealtest Milk with an Nov. 30, 2020 date stamp and a 1 gallon container of Sealtest Milk with an Nov. 27, 2020 date stamp. Now suppose a customer issues a request for 1 gallon of Sealtest Milk. The central computer may transfer the product information for the freshest milk along with the product information for older milk and provide a Substitute-Product-Purchase incentive to purchase such older milk. Notably, when such alternative products are suggested, written or verbal directions and/or a map may be provided to the consumer (via customer interface 62, for example) indicating how to efficiently obtain a substitute product.

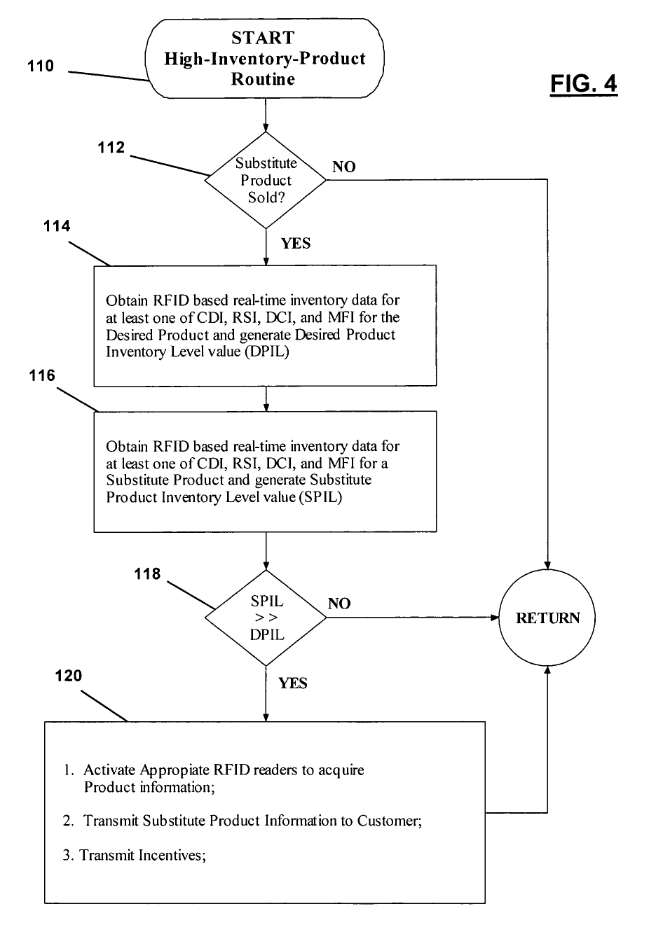

FIG. 4 depicts an exemplary High-Inventory-Product Routine. Step 110 marks the entry into such a routine. At step 112, the computer checks for a possible substitute product. If no substitute product is located, no substitute product is suggested and control of the program is returned to the customer care routine at step 102. If however, a possible substitute product is located, at step 114, the computer accesses inventory data for the desired product at the relevant inventory locations. Similarly, at step 116, the computer accesses inventory data for the relevant inventory locations for the possible substitute product. Here, “inventory data” can represent, for example, the inventory count for the product of interest, the product date stamp or any other appropriate data. Next, at step 118, the computer compares the two inventory data values. If, at step 118, the computer determines that the possible substitute product inventory level value is a predetermined amount greater than the desired product inventory level value, then step 120 is executed. At step 120, the computer initiates a substitute product information data transfer to customer interface 62. In addition, any Substitute-Product-Purchase incentive information may also be transferred to the customer interface. Exemplary Substitute-Product-Purchase incentives include reduction in price, coupons, rebates or any other suitable incentive. After execution of step 120, program control returns to the Customer Care Routine at step 102.

If, at step 118, the central computer determines that a substitute product inventory level is not a predetermined amount greater than the desired product inventory level, then program control simply returns to the customer care routine at step 102.

Returning to FIG. 3 and decision step 104 of the Customer Care Routine, if the central computer determines that the requested product is not sold by the retailer, at step 126, the central computer may initiate a process resulting in a “product-not-sold” message being displayed on display 64 of customer interface 62. Any appropriate product not sold message may be used, such as “Sorry, the requested product is not sold at this location.” The central computer may then execute step 128 and attempt to locate a product that is sold by the retailer that is a possible alternative product for the desired product. If no alternative product is located, execution of the customer care routine returns to step 102 and the computer waits for the next customer generated product request. If, however, an alternative product is located, at step 130, the computer accesses the product information for the alternative product. Such information may be obtained from retailer database 22, distribution database 18, manufacturing database 14, user interface 58, an information source connected to Internet link 60 and/or by instructing the appropriate RFID STR device to scan smart tags associated with the alternative product thereby retrieving at least some of the information stored in such smart tags. At step 132, the central computer initiates an information transfer to customer interface 62 resulting in the displaying, on display 64 of customer interface 62, messages presenting information relating to any one of the following: (1) a message suggesting the purchase of the possible alternative product, (2) a message presenting at least part of the alternative product information, and (3) a message presenting any applicable alternative-product-purchase incentives. Exemplary alternative-product-purchase incentives include coupons, rebate offers, a special sale price or any appropriate incentive to entice the customer to purchase such alternative product.

At step 134, the central computer waits for the customer to accept, decline or skip the alternative product purchase offer. If the customer declines or skips the alternative product purchase offer, execution of the customer care routine returns to step 102 and the central computer waits for another customer generated product request. If at step 134 the customer accepts the alternative product purchase offer, at step 136, the central computer checks the appropriate inventory data source to determine if the desired product is in customer display inventory 38. Such may be accomplished by accessing near real-time inventory data stored in a computer memory or preferably by instructing the appropriate RFID STR device to scan customer display inventory 38 to retrieve real-time inventory data. Alternatively, step 136 could be performed before notifying a customer of a possible alternative product.

Next, at step 138, the central computer initiates a data transfer of any additional product information (e.g. such as the location of the product) to customer display 62. After step 138, the execution of the customer care routine returns to step 102 where the central computer waits for the next customer generated product request.

Returning to step 136, if the central computer determines that the identified alternative product is not in customer display inventory 38, the central computer, at step 140, executes the Restock CDI Routine.

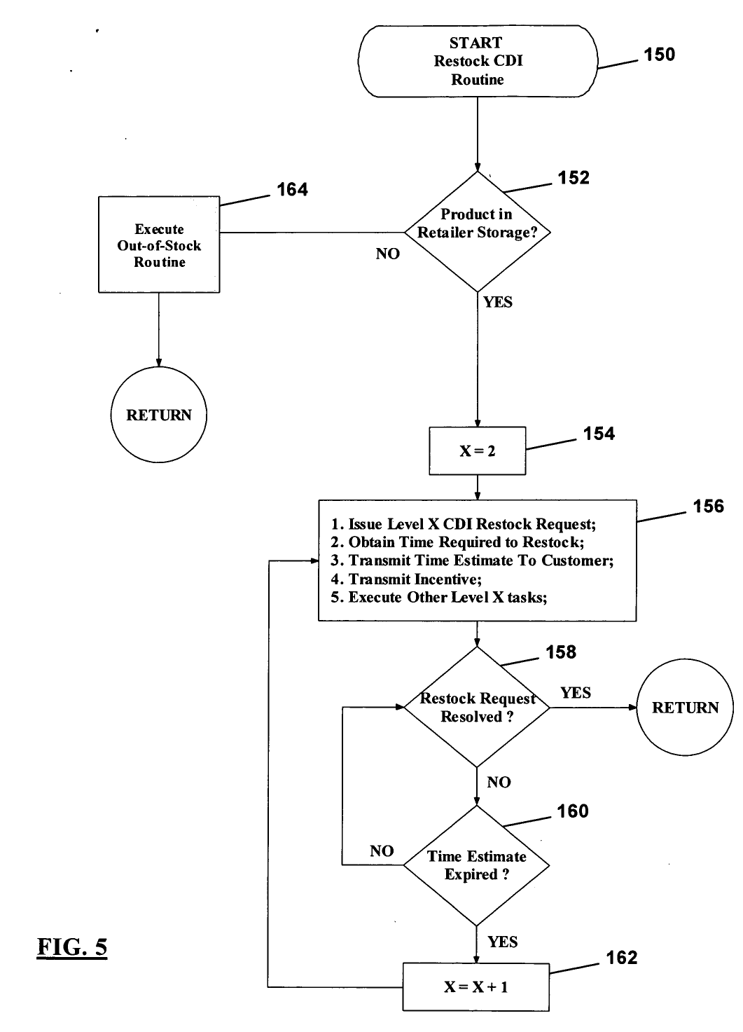

Step 150 (FIG. 5) marks the entry into an exemplary Restock CDI routine. At step 152, the computer determines if a product is in retailer storage 36. It should be noted that any product storage location (such as distribution center inventory storage 34 or a retailer storage located “off-site” of a particular store) may be used to replenish customer display inventory 38. If the desired product is in retailer storage 36, counter value X is set to 2 (step 154). Next, step 156 is executed where the central computer issues a level X (X is the counter value) Restock Request. A level 2 or higher restock request notifies the retailer that a customer is currently waiting for a product that is not currently in customer display inventory 38. Thus, restocking of such an item should be given high priority. The central computer may also request/establish an estimate for the time required to restock the desired product and initiate transfer of such information to customer interface 62. Such time estimate may, for example, be entered by an employee via a user interface 58 or automatically determined by the central computer, perhaps using historical data as a guide. The central computer may also initiate a transfer of information relating to any applicable wait-to-purchase incentives. Such an incentive could be based on the number of items in the customer's shopping cart 74 as determined by instructing a RFID STR device, preferably associated with customer interface 62, to scan the contents of shopping cart 74 (FIG. 2). For example, it is more probable that a customer with 10 items in shopping cart 74 will “wait to purchase” a temporarily out of stock product compared to a customer with no items in shopping cart 74.

Other level X tasks may also be performed while waiting on the desired product to be restocked. Such other tasks may include notifying a store manager of the out of stock condition so that such store manager can monitor the restocking process.

The central computer may also start tracking the elapsed time since issuing the level X restock request. At step 158, the computer determines if the restock request has been resolved. If the restock request has been resolved, program execution returns to the calling routine. In this case, program control simply returns to the Customer Care Routine at step 102. If, at step 158, the computer determines that the restock request has not been resolved, the central computer, at step 160, checks to determine if the elapsed time is longer than the estimated time required to restock the desired item. If the elapsed time is not longer than the estimated time, program execution returns to step 158. If, however, the elapsed time is determined to be longer than the estimated time, the counter X value is increased by 1 (step 162) and program control jumps back to step 156. This loop continues until the desired product is restocked, the customer cancels the restock request, the retailer cancels the restock request, and/or the restock request automatically cancels based on some other criteria.

If at step 152, the central computer determines that product is not in exemplary retailer storage 36, program execution is transferred to step 164 which calls for the execution of an Out-of-Stock Routine.

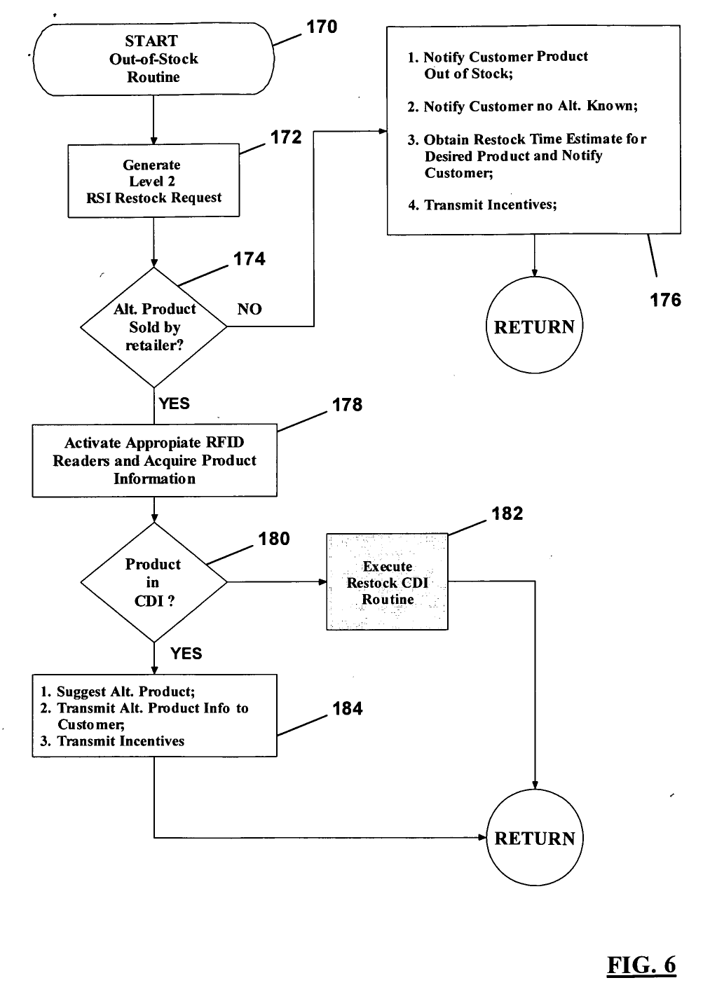

FIG. 6 presents an exemplary Out-of-Stock Routine (170). At step 172, a level 2 retailer storage inventory restock request is issued. A level 2 or higher retailer storage inventory restock request indicates that a retailer store is out-of-stock on an item and that a customer has requested such item. Thus, such a restock request should be given high priority. At step 174, the central computer checks for a possible alternative product to the desired product. If no alternative product is located, step 176 is executed and the central computer transfers a “product out of stock” message to customer interface 62 notifying the customer that the desired product is out of stock. The customer is also notified that no alternative product to the desired product is known to be sold by the retailer. The central computer also obtains a time estimate as to when the desired product will be available and such time estimate is transferred to customer interface 62. In addition, any appropriate come-back-to-purchase incentives are transferred to customer interface 62 and program control is returned to the calling routine.

If, at step 174, the central computer determines that an alternative product is sold by the retailer, step 178 is executed where the computer obtains the relevant alternative product information (in the same manner as previously described) and transfers such information to customer interface 62. In step 180, the central computer verifies the alternative product is in customer display inventory 38 (in the same manner as describe previously). If the product is not in customer display inventory 38, the Restock CDI Routine, previously described, is executed (step 182). Otherwise, the central computer initiates data transfer to the customer interface 62 where (1) a message suggesting the customer consider purchasing the alternative product is displayed, (2) addition product information is displayed, and (3) appropriate alternative-product-purchase incentive information is displayed (step 184).

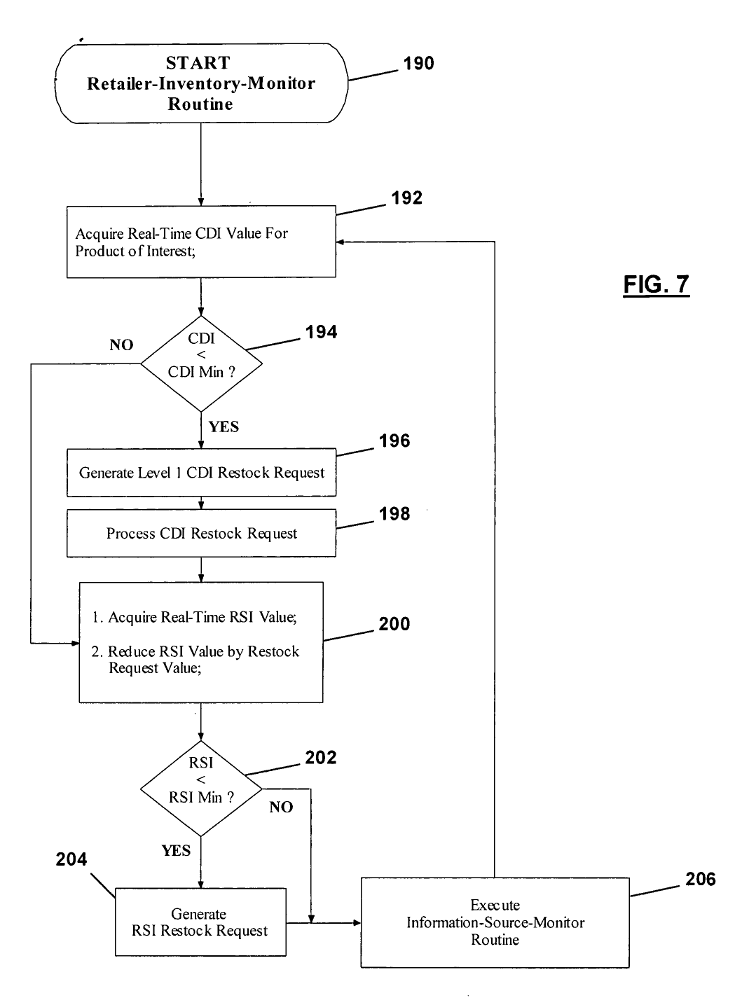

Attention is now turned to an exemplary method for monitoring retailer inventory levels. FIG. 7 presents a block diagram representation of one possible embodiment of such a method. Before describing this inventory monitoring routine, it may prove helpful to describe the goal of such routine. The goal of the Retailer-Inventory-Monitor routine is to prevent products from becoming out-of-stock in a supply chain inventory location, such as manufacturing facility inventory 32, distribution center inventory 34, retailer storage inventory 36 and customer display inventory 38. Considering the customer display inventory 38, at one extreme, every time a product is removed from customer display inventory 38, a retailer employee could replace/restock such product. While such a process would assure that customer display inventory 38 was always fully stocked, such a process may be cost prohibitive. At the other extreme, a retailer could wait until a customer complains about a product being out of stock in customer display inventory 38 before restocking such product. Clearly this solution is not the optimal solution as customers are inconvenienced and sales will likely be lost. Therefore, the optimal inventory level at which a restocking process should begin occurs somewhere between such two extremes. For example, the full inventory level for a particular toothbrush may be 50 toothbrushes and the optimal inventory level for initiating a restocking process may be 20 toothbrushes. A suitable product inventory restocking process would need to monitor the toothbrush inventory level and detect when such inventory level dropped below 20 and initiate a toothbrush restocking process. RFID system 10 provides for such a solution.

Step 190 marks the entry into the Retailer-Inventory-Monitor Routine. At step 192, the central computer acquires a real-time (or near real-time) customer display inventory value for a product of interest located in customer display inventory 38. For simplicity, only one product of interest is referenced in this description, however, such an inventory process may be applied for multiple products at all inventory locations throughout a retailer supply chain. After obtaining a customer display inventory value (CDI Value) for the product of interest, the central computer preferably accesses retailer database 22 to retrieve a predefined customer display minimum value (CDI minimum value) for the product of interest. Such a CDI minimum value may be defined, for example, using well known statistical concepts and historical data describing past customer buying habits and past inventory restocking time requirements. The CDI value is compared to the CDI minimum value (step 194). If the CDI value is determined to be less than the CDI minimum value, a level 1 CDI restock request is issued (step 196). A level 1 CDI restock request notifies a retailer that the inventory level for a particular product has dropped below acceptable levels, however, such retailer also knows that the product of interest is not yet out of stock in customer display inventory 38, unless of course, the CDI minimum value is zero. In the alternative, a generic CDI restock request may be issued simply indicating that a restocking process should be initiated.

Next, at step 198, the CDI restock request is processed. Such CDI processing activities may include, for example, determining the quantity required to service the restock request and subtracting such quantity from retailer storage inventory 36. In step 200, the central computer obtains a real-time (or near real time) retailer storage inventory value (RSI value) and preferably accesses retailer database 22 for an RSI minimum value. The RSI value is compared to the RSI minimum value (step 202). When it is determined that the RSI value is less than the RSI minimum value, a level 1 RSI restock request is generated (step 204). In the alternative, a generic RSI restock request may be issued simply indicating that a restocking process should be initiated.

At step 206, the computer calls for an Information-Source-Monitor routine to be executed. The Information-Source-Monitor routine monitors an information source that provides data relating to “events” that have a generally predictable influence on human behavior when such events do in fact occur. For example, weather conditions, particularly extreme weather conditions, have a generally predictable influence on human behavior. Forecasts of snow may result in more purchases of snow shovels, snow gloves, sleds and milk. Similarly, extremely hot days may result in more purchases of ice, ice cream and cold beverages. Thus, one information source that could be monitored is a web service (Internet web service or private web service) that provides local weather conditions and/or weather predictions.

Another exemplary information source would be sporting event schedules. For example, it has been observed that an increased amount of alcoholic beverages are sold in college towns where the college football team is in town and playing a home game. Thus, a local retailer may find it useful to monitor the local college football team's schedule.

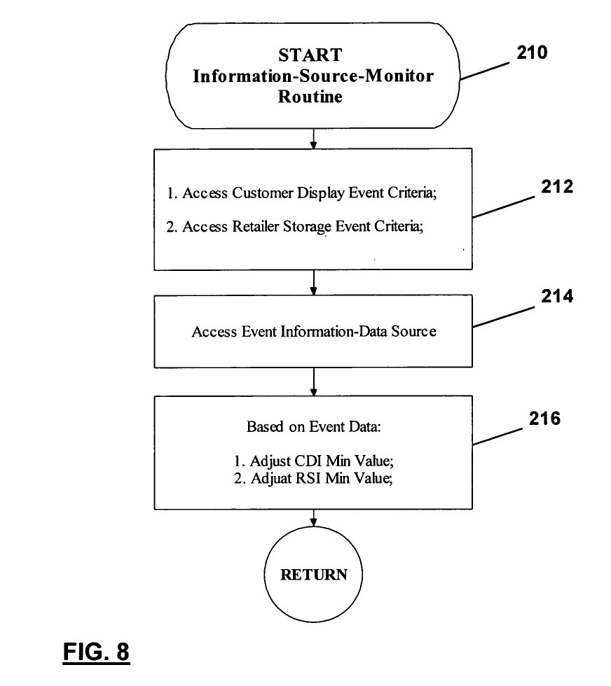

FIG. 8 depicts an exemplary Information-Source-Monitor routine. At step 212, the central computer preferably accesses retailer database 22 to obtain customer display inventory event criteria and retailer storage inventory event criteria. Event criteria may be formatted in any number of ways. One example would be as follows: “Monitor web service Y (step 214). When the predicted high temperature for any day is less than 25 degrees Fahrenheit, increase glove inventory CDI minimum value by 5 units and RSI minimum value by 8 units and increase glove-CDI-minimum-adjustment counter by 1 (step 216). The glove-CDI-minimum-adjustment counter is one exemplary method of keeping track of adjustments and may be used, for example, to return the CDI minimum value to its default level in subsequent days when temperatures are above the exemplary 25 degrees Fahrenheit. One of ordinary skill in the art will appreciate that such event criteria may be generated in any number of ways. One possible method for creating event criteria is to track historical customer buying habits under various “event” conditions and apply valid statistical methods to predict future customer buying patterns.

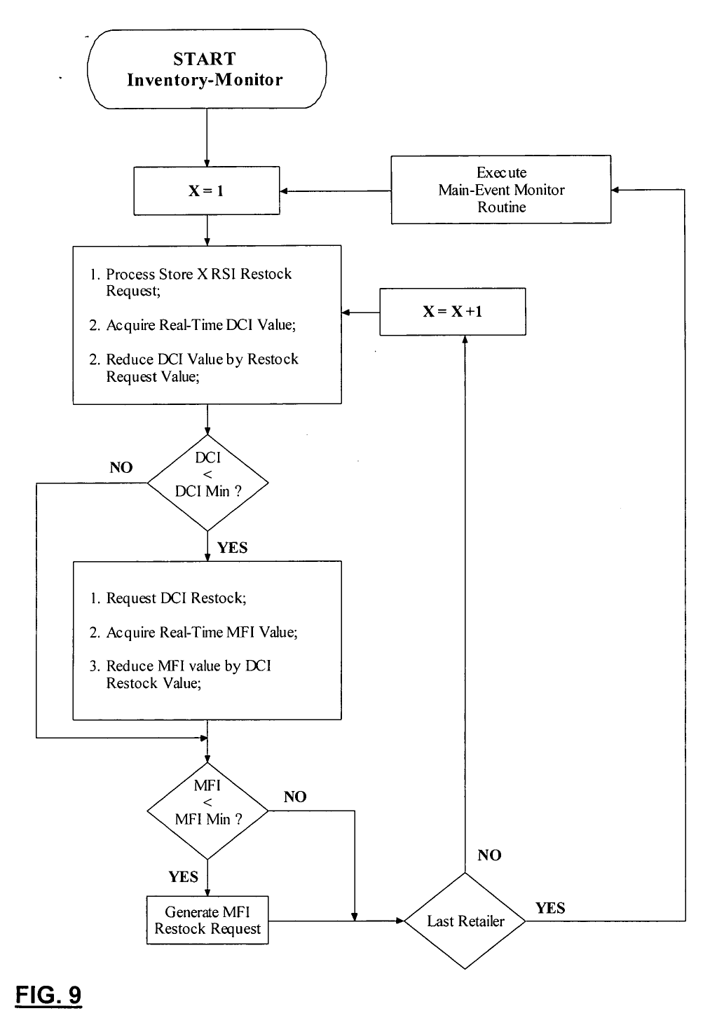

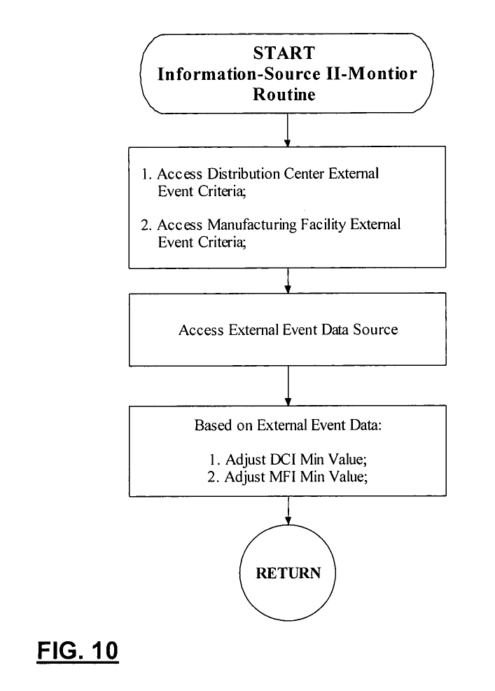

FIGS. 9 and 10 present high level block diagrams depicting the above described inventory monitoring routines as applied at distribution center inventory 34 and manufacturing facility inventory 32. Such routines are sufficiently similar to the above described routines to enable one of ordinary skill in the art to implement such routines and practice the disclosed methods.

While the present subject matter has been described in detail with respect to specific embodiments thereof, it will be appreciated that those skilled in the art, upon attaining an understanding of the foregoing may readily adapt the present technology for alterations to, variations of, and equivalents to such embodiments. Accordingly, the scope of the present disclosure is by way of example rather than by way of limitation, and the subject disclosure does not preclude inclusion of such modifications, variations, and/or additions to the present subject matter as would be readily apparent to one of ordinary skill in the art.

1. A system for providing product information in a supply chain, said system comprising:
at least one electronic tag device associated with products, wherein each distinct product is associated with at least one electronic tag, and wherein said electronic tag is configured to convey product information;
at least one product inventory location for holding said distinct products;
at least one electronic reading device configured to retrieve information from said electronic tag;
an electronic computing device configured to communicate with said electronic reading device and accept, process, store and output said product information;
said electronic computing device further configured to monitor inventory data representing the inventory level of said each distinct product and to initiate action to maintain an inventory level above a predefined minimum inventory level for said each distinct product; and
a customer interface associated with said electronic computing device and configured to present information related to out-of-stock items requested by a customer.

2. A system for providing product information in a supply chain as in claim 1, wherein said inventory data is at least one of (a) real-time data and (b) near real-time data.

3. A system for providing product information in a supply chain as in claim 1, wherein said electronic tag device is an RFID smart tag.

4. A system for providing product information in a supply chain as in claim 3, wherein said electronic reading device is an RFID STR device.

5. A system for providing product information in a supply chain as in claim 4, wherein said computing device is a central computer;

6. A system for providing product information in a supply chain as in claim 1, wherein said customer interface if further configured to receive a customer request for a desired product and to transfer said customer request to said electronic computing device.

7. A system for providing product information in a supply chain as in claim 6, wherein said customer interface is further configured to receive and display product information from at least one of said electronic reading device and said electronic computing device.

8. A retailer inventory system, comprising:
at least one electronic tag device associated with products, wherein each distinct product is associated with at least one electronic tag, and wherein said electronic tag is configured to convey product information;
a plurality of electronic reading devices configured to retrieve information from said at least one electronic tag;
a first network operating in accordance with a predetermined protocol;
a second network comprising said plurality of electronic reading devices each of which includes electronics for reading said at least one electronic tag;
a gateway operatively coupled to said first network and to said second network; and
an HTTP server embedded in one of (1) said gateway and (2) said plurality of electronic reading devices, for accessing said product information.

9. A retailer inventory system as in claim 8, wherein said electronic tag device is an RFID smart tag.

10. A retailer inventory system as in claim 8, wherein said electronic reading device is an RFID STR device.

11. A retailer inventory system as in claim 8, further comprising a customer interface.

12. A retailer inventory system as in claim 8, wherein said gateway provides continuous access to said second network.

13. A method for managing products in a supply chain, said method comprising:
associating RFID smart tags with products, wherein each distinct product is associated with at least one smart tag, the smart tags containing product information regarding their respective product;
storing at least one said distinct product in a first inventory location;
providing at least one RFID STR within communication distance of said at least one smart tag;
providing a customer interface;
providing a first computer configured to communicate with said at least one RFID STR and said customer interface;
configuring said customer interface to receive a customer request for a desired product and to transfer said customer request to at least one of said first computer and said at least one RFID STR;
configuring at least one of said first computer and said at least one RFID STR to initiate a transfer of said product information, for the desired product, to said customer interface upon receiving said customer request; and
wherein said product information comprises information related to out-of-stock events when said desired product is determined to be out-of-stock in said first inventory location.

14. A method for managing products in a supply chain as in claim 13, wherein said customer request is at least one member of the group consisting of: (1) a customer request generated by the customer manually entering the request into the customer interface; (2) a customer request generated over the Internet and stored in a database; (3) a customer request generated by speaking into the customer interface; and (4) a customer request that is transmitted from a portable electronic device to said customer interface.

15. A method for managing products in a supply chain as in claim 13, further comprising the step of providing a second inventory location;

16. A method for managing products in a supply chain as in claim 15, wherein said first inventory location is a customer display inventory location and said second inventory location is a retailer storage inventory location.

17. A method for managing products in a supply chain as in claim 15, further comprising the step of configuring said first computer to determine when an substitute product to the desired product is sold by the retailer, and if so, performing the following steps:
requesting said at least one RFID STR to scan said first inventory location and said second inventory location to obtain a substitute product inventory count and a desired product inventory count;
transferring to said customer interface substitute product information and a substitute-product-purchase incentive when said substitute product inventory count minus said desired product inventory count exceeds a predefined value.

18. A method for managing products in a supply chain as in claim 17, wherein said substitute product is one of (a) the same brand of product as the desired product and the same type of product as the desired product but having a different expiration date than the desired product, and (b) the same type of product as the desired product but being a different brand of product from the desired product.

19. A method for managing products in a supply chain as in claim 18, further comprising the step of configuring said first computer to request said at least one RFID STR to scan said first inventory location to determine if said desired product is available in said first inventory location and to perform the following steps when said desired product is not in said first inventory location:
issue a said first inventory location restock request;
transfer a product being restocked message to said customer interface;
transfer a desired product restock time estimate to said customer interface; and
transfer a wait-to-purchase incentive to said customer interface.

20. A method for managing products in a supply chain as in claim 19, further comprising the step of configuring said first computer to perform any combination of the following first inventory location restock steps:
to determine when said desired product restock time estimate has expired without said desired product being restocked;
to establish a new desired product restock time estimate and to transfer said new desired product restock time estimate to said customer interface;
to transfer to said customer interface a wait-to-purchase incentive; and
to repeat said first inventory location restock steps until the occurrence of at least one event from the group of events consisting of (1) said desired product is restocked; (2) customer cancels restock request; (3) retailer cancels restock request; and (4) restock request automatically cancels.

21. A method for managing products in a supply chain as in claim 19, further comprising the steps of configuring said first computer to determine when said desired product is out of stock and to transfer an out of stock message to said customer interface and to transfer to said customer interface a come-back-to-purchase incentive.

22. A method for managing products in a supply chain as in claim 22, further comprising the steps of:
configuring said first computer to determine if an alternative product to said desired product is sold; and
configuring said first computer to acquire alternative product information and to transfer said alternative product information to said customer interface.

23. A method for managing products in a supply chain as in claim 22, further comprising the step of configuring said first computer to transfer an alternative-product-purchase incentive to customer interface.

24. A method for managing products in a supply chain as in claim 13, further comprising the step of determining when said desired product is not sold by the retailer and transferring a product-not-sold message to said customer interface.

25. A method for managing products in a supply chain as in claim 24, further comprising the step configuring said first computer to locate any alternative products sold by the retailer, to access at least one data source containing alternative product information, and to initiate a transfer of at least part of said alternative product information to said customer interface.

26. A method for managing products in a supply chain as in claim 25, wherein said at least one data source containing alternative product information is at least one of (a) a database and (b) a RFID STR device.

27. A method for managing products in a supply chain as in claim 25, further comprising the step of transferring an alternative-product-purchase incentive to said customer interface.

28. A method for managing products in a supply chain as in claim 13, further comprising the step of configuring said first computer to determine when a substitute product to the desired product is sold by the retailer, and if so, performing the following steps:
requesting said at least one RFID STR to scan said first inventory location to obtain a substitute product inventory count and a desired product inventory count;
transferring to said customer interface substitute product information and a substitute-product-purchase incentive when said substitute product inventory count minus said desired product inventory count exceeds a predefined value.

29. A method for managing products in a supply chain, said method comprising:
associating RFID smart tags with products, the smart tags containing information regarding their respective product;
providing a first inventory location and placing said RFID smart tagged products in said first inventory location;
providing at least one RFID STR within communication distance of said RFID smart tags;
providing a central computer configured to communicate with said at least one RFID STR;
configuring said central computer to use said at least one RFID STR to acquire a first inventory location count for said RFID smart tagged products;
comparing said first inventory location count to a predefined first inventory location minimum value for respective products; and
generating a first inventory location restock request when said first inventory location count drops below said predefined first inventory location minimum value.

30. A method for managing products in a supply chain as in claim 29, wherein said step of generating a first inventory location restock request is one of a manual request and an automatic request.

31. A method for managing products in a supply chain as in claim 29, wherein said first inventory location count is one of a real-time count and a near real-time count.

32. A method for managing products in a supply chain as in claim 29, further comprising the steps of:
configuring said central computer to access event criteria for at least one said RFID smart tagged products;
configuring said central computer to monitor at least one information-data source; and
configuring said central computer to adjust said predefined first inventory location minimum value in response to data received from said at least one information-data source in light of said event criteria.

33. A method for managing products in a supply chain as in claim 32, wherein said information-data source is one of a webservice and a computer database.

34. A method for managing products in a supply chain as in claim 29, further comprising the steps of:
providing a second inventory location and placing said RFID smart tagged products in said retailer storage inventory location.
configuring said central computer to use said at least one RFID STR to acquire a second inventory location count for said RFID smart tagged product;
configuring said central computer to compare said second inventory location count to a predefined second inventory location minimum value for respective products; and
generating a second inventory location restock request when said second inventory location count drops below said predefined second inventory location inventory minimum value.

35. A method for managing products in a supply chain as in claim 34, further comprising the steps of:
configuring said central computer to access event criteria for said RFID smart tagged products;
configuring said central computer to monitor at least one information-data source; and
configuring said central computer to adjust said predefined second inventory location minimum value in response to data received from said information-data source in light of said event criteria.

36. A method for managing products in a supply chain as in claim 35, wherein said information-data source is one of a webservice and a computer database.

37. A method for managing products in a supply chain as in claim 35, wherein said first inventory location is a customer display inventory location and said second inventory location is a retailer storage inventory location.

38. A method for managing products in a supply chain, said method comprising:
associating RFID smart tags with products, the smart tags containing information regarding their respective product;
providing at least one distribution center inventory location;
storing said products at said distribution center inventory location;
providing at least one RFID STR within communication distance of said RFID smart tags;
providing a central computer configured to communicate with said at least one RFID STR;
configuring said central computer to use said at least one RFID STR to acquire a distribution center inventory count for at least one said distinct product; and
generating a distribution center inventory restock request when said distribution center inventory count drops below said predefined distribution center inventory minimum value.

39. A method for managing products in a supply chain as in claim 38, wherein said RFID smart tags are associated with said products at said distribution center.

40. A method for managing products in a supply chain as in claim 38, further comprising the steps of:
providing at least one retailer storage inventory location;
storing at least one RFID smart tagged product in said retailer storage inventory;
configuring said central computer to initiate a retailer storage inventory restock process when said distribution center database receives a retailer storage inventory restock request;

41. A method for managing products in a supply chain as in claim 38, further comprising the steps of:
configuring said central computer to access event criteria for said at least one smart tagged product;
configuring said computer to monitor at least one information-data source; and
configuring said computer to adjust said predefined distribution center inventory minimum value in response to data received from said at least one information-data source in light of said event data.

42. A method for managing an out-of-stock event comprising the steps of:
placing products associated with at least one electronic tag in a first-inventory location and a second-inventory location;
receiving a customer request for a desired product;
determining when said desired product is not presently in said first-inventory location but is presently in said second-inventory location using at least one of real-time inventory data and near real-time inventory data for said first-inventory location and said second inventory-location; and
performing the following steps when it is determined that said desired product is not in said first-inventory location but is in said second-inventory location:
(a) notifying said customer that said desired product is temporarily out-of-stock in said first-inventory location;
(b) notifying said customer that said desired product is in said second-inventory location and that a restock request has been initiated;
(c) presenting said customer with an estimated time required to restock said desired product;
(d) providing said customer with a wait-to-purchase incentive.

43. A method for managing an out-of-stock event as in claim 42, further comprising the step of offering said customer a come-back-to-purchase incentive when said customer declines said wait-to-purchase incentive.

44. A method for managing an out-of-stock event as in claim 42, further comprising the step of offering said customer a come-back-to-purchase incentive when it is determined that said desired product is not in said first-inventory location and not in said second-inventory location.

45. A method for managing an out-of-stock event as in claim 42, wherein said electronic tag is an RFID smart tag.

46. A method for managing an out-of-stock event as in claim 42, wherein said first-inventory location is a customer-display-inventory location and wherein said second-inventory location is at least one of: (a) a retailer-storage-inventory location; (b) a loading dock; (c) an off-site retailer storage; (d) a second retailer store; (e) a manufacturer storage location; and (f) a distribution center storage location.

47. A method for managing an out-of-stock event comprising the steps of:
placing products associated with at least one electronic tag in a first-inventory location and a second-inventory location;
determining when a customer is searching for a desired-product in a first-inventory location;
automatically determining when said desired product is presently out-of-stock in said first-inventory location;
automatically determining when said desired product is in a second-inventory location;
automatically notifying said customer that said desired product is not in said first-inventory location but is in said second-inventory location;
presenting said customer with at least one of the following:
(a) offer in-store delivery of said desired product;
(b) offer out-of-store delivery of said desired product;
(c) offer to have said desired product available at a point-of-sale where said customer is to check-out;
(d) offer a wait-to-purchase incentive; and
(e) offer an alternative-product purchase incentive.

48. A method for managing an out-of-stock event as in claim 47, wherein said step of determining when a customer is looking for a desired product in a first-inventory location comprises at least one of the following:
(a) detecting when said customer pushes a button next to a first-inventory location that has an out-of-stock product;
(b) detecting when said customer's location remains substantially fixed near a first-inventory location that has an out-of-stock product; and
(c) detecting when a customer-interface associated with said customer remains substantially fixed near a first-inventory location that has an out-of-stock product.

49. A method for managing an out-of-stock event as in claim 47, further comprising the step of determining when said desired product is not in said first-inventory location and not in said second-inventory location and offering said customer at least one of the following: (a) a come-back-to-purchase incentive; (b) out-of-store delivery of said desired product to a customer designated location; and (c) offer an alternative-product purchase incentive.

50. A method for managing an out-of-stock event as in claim 47, wherein said electronic tag is an RFID smart tag.
